(19) United States
(12) Patent Application Publication
(10) Pub. No.: US 2013/0164090 A1
(43) Pub. Date: Jun. 27, 2013

(54) Multi-Spindle Hobbing Machine

(71) Applicants: Urs Buttler, Grenchen (CH); Simon Walter, Orpund (CH)

(72) Inventors: Urs Buttler, Grenchen (CH); Simon Walter, Orpund (CH)

(73) Assignee: NEW WYSSBROD TECHNOLOGY AG, Rapperswil-Jona (CH)

(21) Appl. No.: 13/579,088

(22) PCT Filed: Feb. 17, 2011
(86) PCT No.: PCT/EP11/52340

§ 371 Date: Dec. 11, 2012

(30) Foreign Application Priority Data
Feb. 18, 2010 (EP) 10405030.7

(51) Int. Cl. B23F 17/00

(52) U.S. Cl. CPC B23F 17/00
USPC 409/16

(57) ABSTRACT

The invention relates to a hobbing machine for simultaneously hobbing n workpieces, comprising an n-fold milling head having n milling spindle axes that are parallel to one another, an n-fold tailstock and an n-fold workpiece spindle carrier having n workpiece spindle axes that are parallel to each other in a first horizontal main axis direction. The n-fold workpiece spindle carrier and the n-fold tailstock comprise n workpiece spindle carrier units or tailstock units which can be moved individually in a second horizontal main axis direction perpendicular to the first horizontal main axis direction along horizontal movement axes.

### TECHNICAL FIELD

The invention relates to a hobbing machine for hobbing n workpieces at the same time, having an n-fold milling head with n milling spindle axes which lie parallel to one another, an n-fold tailstock and an n-fold workpiece headstock with n workpiece spindle axes which lie parallel to one another in a first horizontal main axial direction.

### PRIOR ART

A 3-spindle production or tool milling machine from the company Wyssbrod Technologie AG for the material-removing circumferential machining of three workpieces at the same time is known under the designation CNC 7-4A. The three milling spindles are at a fixed spacing from one another and are connected to a central drive unit via a gear mechanism. The 3-fold tailstock and the 3-fold workpiece headstock are arranged movably on a common workpiece spindle and tailstock table.

Highly precise undulating workpieces such as gearwheels and worms of gear mechanisms cannot be manufactured within the required tolerances on the known 3-spindle milling machines CNC 7-4A. The hobbing of highly precise gearwheel geometries which are hobbed on turned part blanks has therefore taken place up to now on 1-spindle hobbing machines with acceptance of a correspondingly reduced production output.

### SUMMARY OF THE INVENTION

The invention is based on the object of providing a multi-spindle hobbing machine of the type mentioned at the outset, by way of which multi-spindle hobbing machine highly precise gearwheel geometries may be milled efficiently.

The achievement according to the invention of the object is reached by the fact that the n-fold workpiece headstock and the n-fold tailstock have n workpiece headstock units and tailstock units which can be displaced individually along horizontal displacement axes in a second horizontal main axial direction at right angles to the first horizontal main axial direction, where n is greater than 1.

The precision setting according to the invention makes it possible to correct different milling diameters and pitch errors per milling tool and per milling spindle with respect to the workpiece axis. A correction of the cylindricity per milling spindle is also possible. Therefore, n, that is to say two, three or more, workpieces can be milled at the same time with high precision with regard to cylindricity. The output of parts is increased by a factor n, as a rule by a factor 2 or 3.

The workpiece headstock units and tailstock units which are separate and can be moved individually in the second horizontal main axial direction make a simple and rapid correction possible of different milling diameters and of the conicity. Corrections can therefore be corrected via a simple control operation for the calibration of the tooth depth, even in the case of different milling diameters, and the conicity, as in the case of a 1-spindle hobbing machine.

The n workpiece headstock units are preferably equipped with in each case one workpiece spindle drive unit.

In one expedient embodiment, the n tailstock units are fixed on in each case one longitudinal carriage which can be displaced individually along horizontal displacement axes in the first horizontal main axial direction, and each longitudinal carriage is fixed on in each case one transverse carriage which can be displaced individually along the horizontal displacement axes in the second horizontal main axial direction.

The n workpiece headstock units are preferably fixed on in each case one transverse carriage which can be displaced individually along horizontal displacement axes in the second horizontal main axial direction.

The n-fold milling head is preferably fixed on a vertical carriage which can be displaced along a vertical displacement axis in a vertical main axial direction.

In a preferred embodiment, the n-fold milling head is fixed on the vertical carriage such that it can be pivoted about a milling head pivot axis which lies in the second horizontal main axial direction.

In a further preferred embodiment, an n-fold counterbearing milling head which can be displaced along a displacement axis which lies in the direction of the milling spindle axes lies opposite the n-fold milling head.

The stability of the milling head allows milling to be carried out by way of floating hobs. If the milling head is designed for the use of end mills having a counterbearing milling head, a desired nonpositive connection between the milling head and the counterbearing milling heads and additional stability are achieved.

### BRIEF DESCRIPTION OF THE DRAWING

Further advantages, features and details of the invention result from the following description of preferred exemplary embodiments and using the drawing, in which, schematically:

FIG. 1 shows a perspective view of a hobbing machine,

FIG. 2 shows a plan view of the hobbing machine from FIG. 1,

FIG. 3 shows a front view of the hobbing machine from FIG. 1,

FIG. 4 shows a side view of the hobbing machine from FIG. 1, in the viewing direction M according to FIG. 3, and

FIG. 5 shows a side view of the hobbing machine from FIG. 1, in the viewing direction N according to FIG. 3.

### DESCRIPTION OF EXEMPLARY EMBODIMENTS

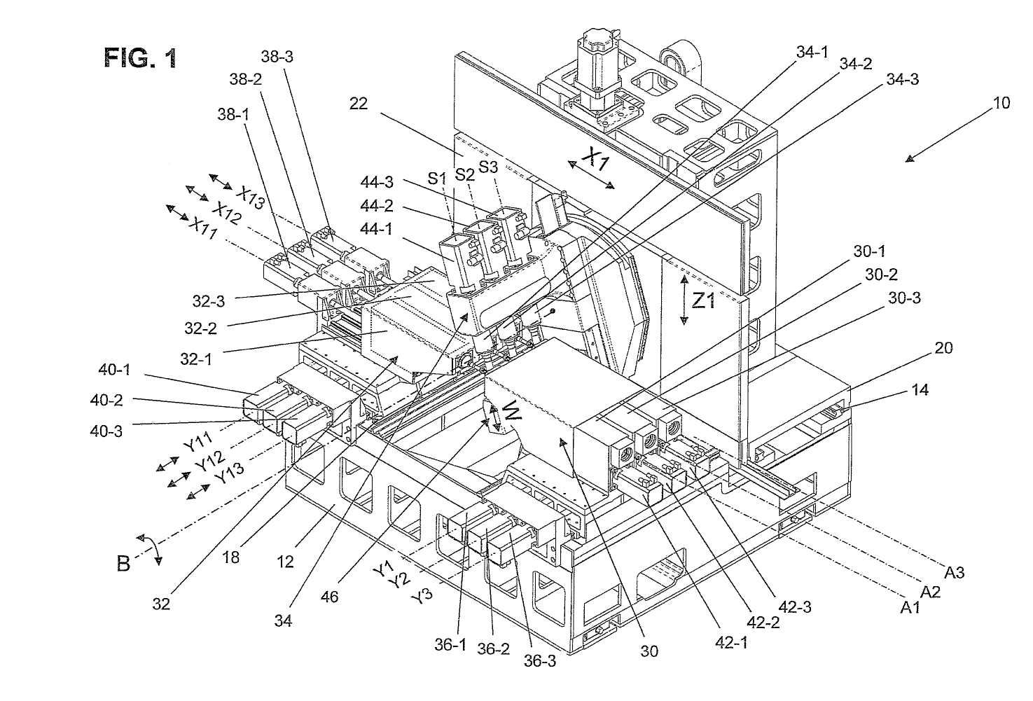

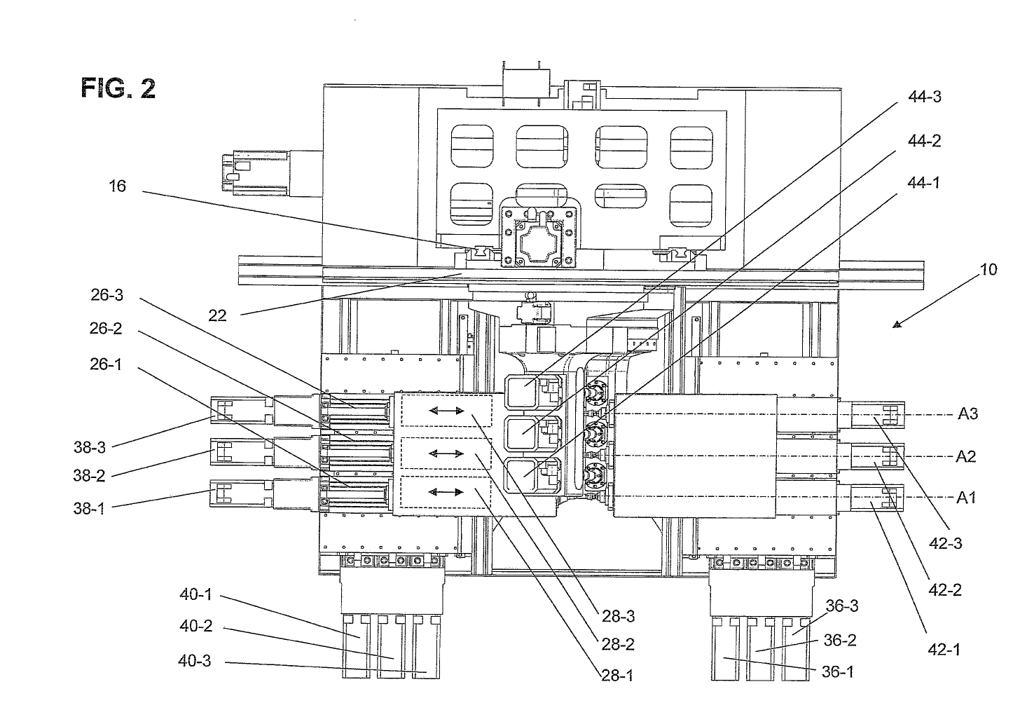

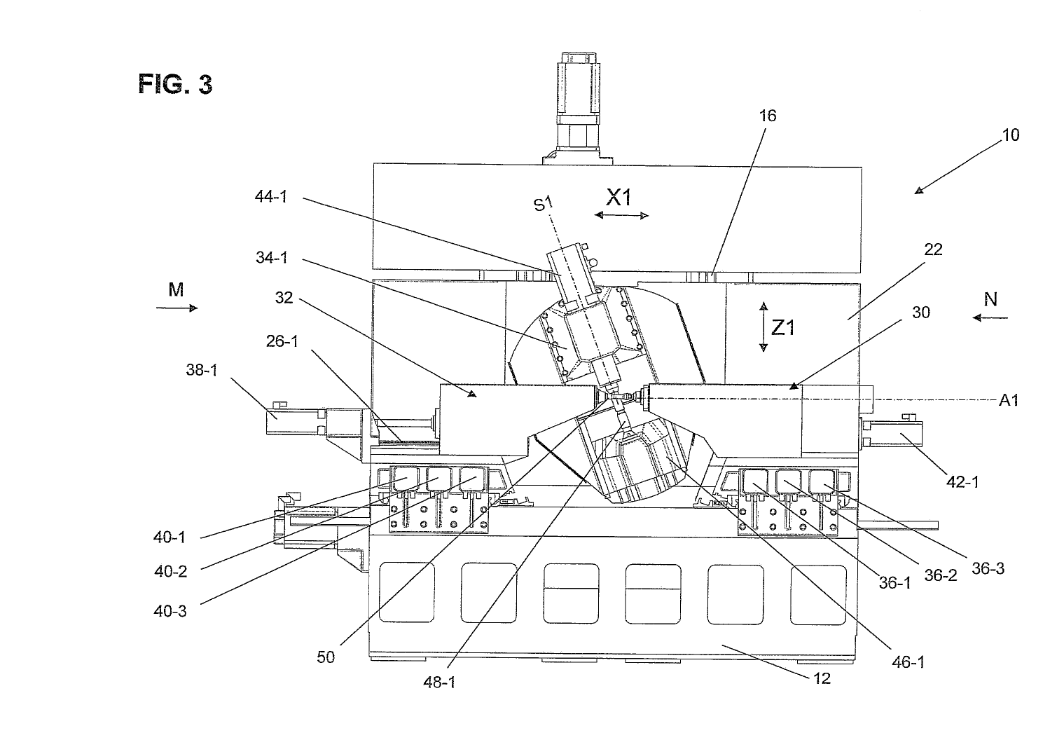

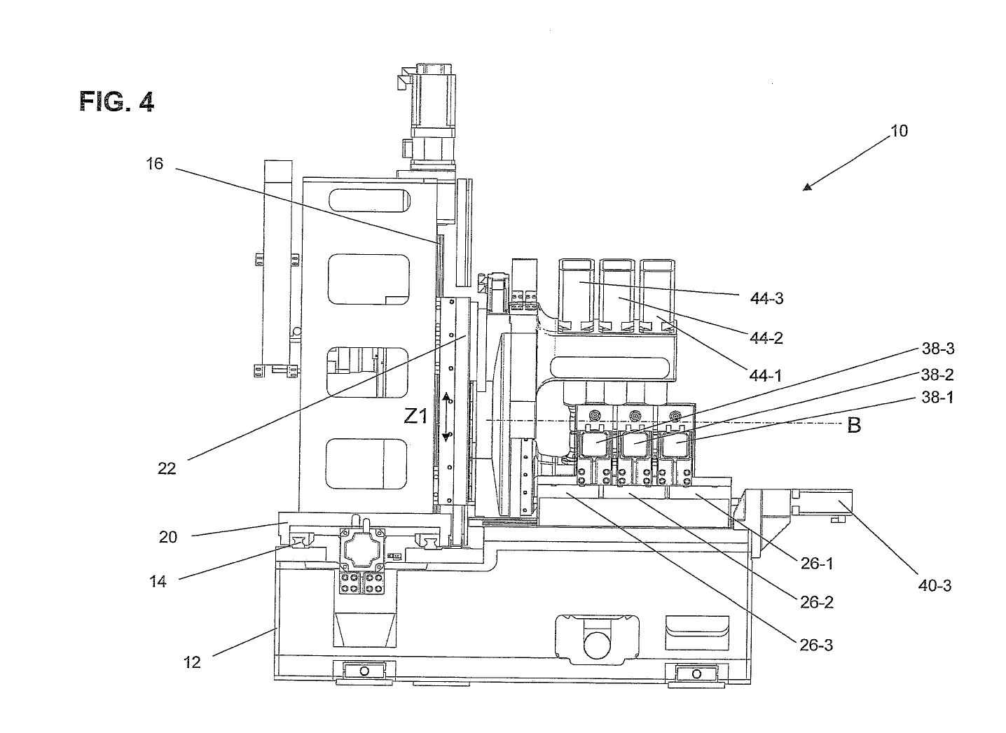

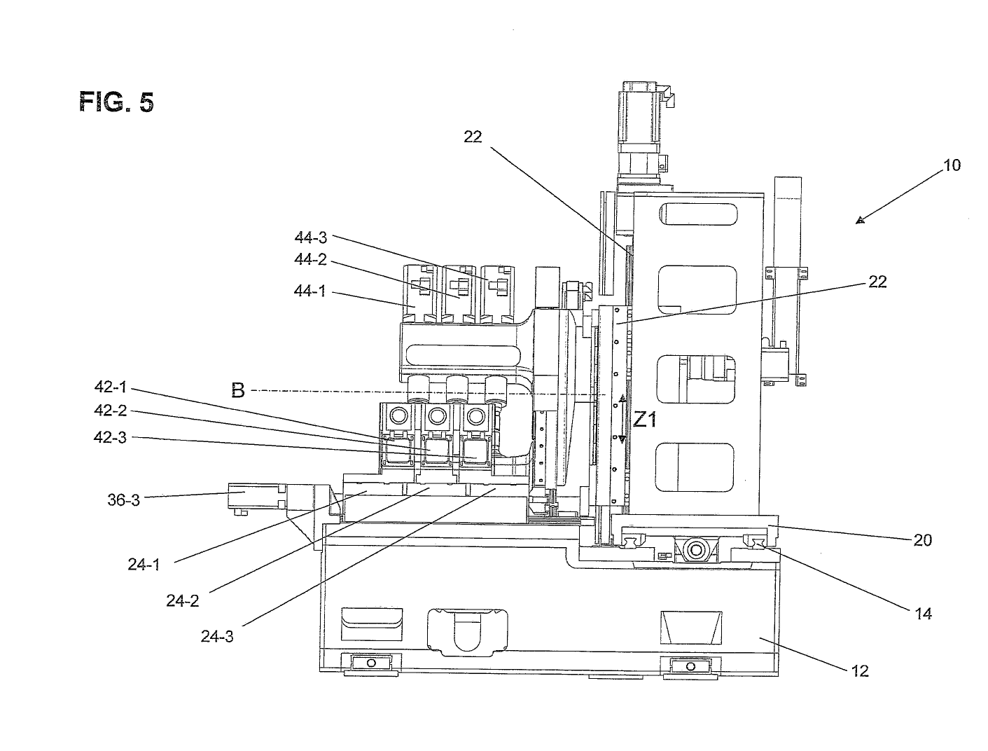

A three-spindle hobbing machine 10 which is shown in FIG. 1 to 5 for the simultaneous milling of three toothing systems on three workpieces in the form of turned parts comprises a torsionally rigid machine body 12 and stationary parts 14, 16, 18 of linear guides, which lie in the three main axial directions X, Y, Z which lie at right angles to one another, of an axial carriage or stand 20, of a vertical carriage 22, and of in each case three radial or transverse carriages 24-1, 24-2, 24-3 and 26-1, 26-2, 26-3 for in each case three workpiece headstock units 30-1, 30-2, 30-3 and tailstock units 32-1, 32-2, 32-3 of a 3-fold workpiece headstock 30 and tailstock 32.

The stationary linear guide parts 14 which are fixed on the machine body 12 lie in the first horizontal main axial direction X and, as parts of an axial carriage guide, make the linear displacement of the axial carriage 20 possible along a horizontal displacement axis X1 in the first horizontal main axial direction X.

The stationary linear guide parts 18 which are likewise fixed on the machine body 12 lie in the second horizontal main axial direction Y and, as parts of transverse carriage guides, make the linear displacement of the transverse carriages 24-1, 24-2, 24-3 and 26-1, 26-2, 26-3 for the workpiece headstock units 30-1, 30-2, 30-3 and tailstock units 32-1, 32-2, 32-3 possible along horizontal displacement axes Y1, Y2, Y3; Y11, Y12, Y13 in the second horizontal main axial direction Y.

The stationary linear guide parts 16 which are fixed on the axial carriage 20 lie in the vertical main axial direction Z and, as parts of a vertical carriage guide, make the linear displacement of the vertical carriage 22 possible along a vertical displacement axis Z1 in the vertical main axial direction Z.

Each of the three workpiece headstock units 30-1, 30-2, 30-3 is mounted on in each case one transverse carriage 24-1, 24-2, 24-3 and can be moved individually along the horizontal displacement axes Y1, Y2, Y3 in the second horizontal main axial direction Y by means of in each case one drive unit 36-1, 36-2, 36-3 which is assigned to each transverse carriage 24-1, 24-2, 24-3.

Each of the three tailstock units 32-1, 32-2, 32-3 is mounted on in each case one longitudinal carriage 28-1, 28-2, 28-3 and can be moved individually along the horizontal displacement axes X11, X12, X13 in the first horizontal main axial direction X by means of in each case one drive unit 38-1, 38-2, 38-3 which is assigned to each longitudinal carriage 28-1, 28-2, 28-3. Each of the three longitudinal carriages 28-1, 28-2, 28-3 is mounted on in each case one transverse carriage 26-1, 26-2, 26-3 and can be moved individually along the horizontal displacement axes Y11, Y12, Y13 in the second horizontal main axial direction Y by means of in each case one drive unit 40-1, 40-2, 40-3 which is assigned to each transverse carriage 26-1, 26-2, 26-3. The described combination of a longitudinal carriage and a transverse carriage is also called a cross carriage.

In milling operation, the three tailstock units 32-1, 32-2, 32-3 of the 3-fold tailstock 32 lie opposite the three workpiece headstock units 30-1, 30-2, 30-3 of the 3-fold workpiece headstock 30 and form three parallel workpiece spindle axes A1, A2, A3 which lie in the first horizontal main axial direction X.

Each workpiece headstock unit 30-1, 30-2, 30-3 can be driven individually via in each case one drive unit 42-1, 42-2, 42-3. The workpieces 50 which are clamped in between corresponding workpiece headstock units 30-1, 30-2, 30-3 and tailstock units 32-1, 32-2, 32-3 and the rotational axis of which lies in the corresponding workpiece spindle axis A1, A2, A3 are accelerated to a predefined rotational speed by the three drive units 42-1, 42-2, 42-3.

A 3-fold milling head 34 is fixed on the vertical carriage 22 such that it can be pivoted about a milling head pivot axis B which lies in the second horizontal main axial direction Y. The 3-fold milling head 34 comprises three milling head units 34-1, 34-2, 34-3 which are equipped with in each case one dedicated main spindle drive 44-1, 44-2, 44-3 and have in each case one milling tool 48-1, 48-2, 48-3.

Together with the end-mounted milling tools 48-1, 48-2, 48-3, the three milling head units 34-1, 34-2, 34-3 form three milling spindle axes S1, S2, S3 which lie parallel to one another in a common plane and are at right angles to the milling head pivot axis B.

The spacing between adjacent milling spindle axes S1-S2 and S2-S3 is substantially equally great for a 3-fold milling head within usual manufacturing tolerances and corresponds to the spacing between adjacent workpiece spindle axes A1-A2 and A2-A3. In order to manufacture highly precise machined parts, it is therefore required to set the milling tools and the turned part blanks 50 individually to one another, which turned part blanks 50 are clamped in between the workpiece headstock units 30-1, 30-2, 30-3 and the tailstock units 32-1, 32-2, 32-3.

The setting of a predefined lateral spacing between mutually corresponding milling spindle axes and workpiece spindle axes takes place in practice by individual displacement of each individual tool headstock unit/tailstock unit pair, until the predefined lateral spacing between the milling and workpiece spindle axis pairs S1-A1, S2-A2 and S3-A3 is reached.

The stability of the 3-fold milling head allows milling to be carried out by way of three floating hobs.

The milling head 34 which is shown in the drawing and can be pivoted automatically about the B-axis is designed for the use of end mills with a counterbearing milling head 46. The 3-fold counterbearing milling head 46 comprises three counterbearing milling head units 46-1, 46-2, 46-3 and can be displaced parallel to the milling spindle axes S1, S2, S3 in a linear displacement axis (W-axis). The milling tools are changed via a hydraulic tool clamping means. An adjustment of the counterbearing milling head 46 can be made to the precise counterbearing diameter by way of the linearly movable W-axis. A desired nonpositive connection between the milling head 34 and the counterbearing milling head 46 and additional stability are therefore achieved.

The shifting, that is to say the displacement movement of the milling head 34 in the direction of the milling spindle axes S1, S2, S3 takes place by means of interpolation between the vertical axis Z1 and the horizontal displacement axis or stand longitudinal axis X1. The shift software which is used automatically calculates the linear travel analogously to the oblique position of the three milling spindle axes S1, S2, S3. An intermediate carriage can thus be omitted and a stronger construction can be built.

All the linear displacement axes X1, X11, X12, X13, Y1, Y2, Y3, Y11, Y12, Y13, Z1 and the rotational axes S1, S2, S3 and A1, A2, A3 and the milling head pivot axis B are advantageously NC axes.

### LIST OF DESIGNATIONS

10 Hobbing machine
12 Machine body
14, 16, 18 Linear guide parts on 12
20 Axial carriage
22 Vertical carriage
24-1, -2, -3 Transverse carriages
26-1, -2, -3 Transverse carriages
28-1, -2, -3 Longitudinal carriages
30 Workpiece headstock
30-1, -2, -3 Workpiece headstock units
32 Tailstock
32-1, -2, -3 Tailstock units
34 Milling head
34-1, -2, -3 Milling head units
36-1, -2, -3 Drive units for 24-1, -2, -3
38-1, -2, -3 Drive units for 32-1, -2, -3
40-1, -2, -3 Drive units for 26-1, -2, -3
42-1, -2, -3 Drive units for 30-1, -2, -3
44 Main spindle drives for 34-1, -2, -3
46 Counterbearing milling head
46-1, -2, -3 Counterbearing milling head units
48-1, -2, -3 Milling tools
50 Workpieces
X1 . . . Horizontal displacement axes in the X-direction
Y1 . . . Horizontal displacement axes in the Y-direction
Z1 Vertical displacement axis in the Z-direction
A1, A2, A3 Workpiece spindle axes
S1, S2, S3 Milling spindle axes
B Milling head pivot axis
W Counterbearing milling head displacement axis

1. A hobbing machine for hobbing n workpieces at the same time, comprising:
an n-fold milling head with n milling spindle axes which lie parallel to one another, an n-fold tailstock and an n-fold workpiece headstock with n workpiece spindle axes which lie parallel to one another in a first horizontal main axial direction, wherein the n-fold workpiece headstock and the n-fold tailstock have n workpiece headstock units and tailstock units which can be displaced individually along horizontal displacement axes in a second horizontal main axial direction at right angles to the first horizontal main axial direction, where n is greater than 1.

2. The hobbing machine as claimed in claim 1, wherein n is equal to 2 or 3.

3. The hobbing machine as claimed in claim 1, wherein the n workpiece headstock units are equipped with in each case one workpiece spindle drive unit.

4. The hobbing machine as claimed in claim 1, wherein the n tailstock units are fixed on in each case one longitudinal carriage which can be displaced individually along horizontal displacement axes in the first horizontal main axial direction, and each longitudinal carriage is fixed on in each case one transverse carriage which can be displaced individually along the horizontal displacement axes in the second horizontal main axial direction.

5. The hobbing machine as claimed in claim 1, wherein the n workpiece headstock units are fixed on in each case one transverse carriage which can be displaced individually along horizontal displacement axes in the second horizontal main axial direction.

6. The hobbing machine as claimed in claim 1, wherein the n-fold milling head is fixed on a vertical carriage which can be displaced along a vertical displacement axis in a vertical main axial direction.

7. The hobbing machine as claimed in claim 6, wherein the n-fold milling head is fixed on the vertical carriage such that it can be pivoted about a milling head pivot axis which lies in the second horizontal main axial direction.

8. The hobbing machine as claimed in claim 7, wherein an n-fold counterbearing milling head which can be displaced along a displacement axis which lies in the direction of the milling spindle axes lies opposite the n-fold milling head.

9. The hobbing machine as claimed in claim 2, wherein the n workpiece headstock units are equipped with in each case one workpiece spindle drive unit.

10. The hobbing machine as claimed in claim 2, wherein the n tailstock units are fixed on in each case one longitudinal carriage which can be displaced individually along horizontal displacement axes in the first horizontal main axial direction, and each longitudinal carriage is fixed on in each case one transverse carriage which can be displaced individually along the horizontal displacement axes in the second horizontal main axial direction.

11. The hobbing machine as claimed in claim 3, wherein the n tailstock units are fixed on in each case one longitudinal carriage which can be displaced individually along horizontal displacement axes in the first horizontal main axial direction, and each longitudinal carriage is fixed on in each case one transverse carriage which can be displaced individually along the horizontal displacement axes in the second horizontal main axial direction.

12. The hobbing machine as claimed in claim 2, wherein the n workpiece headstock units are fixed on in each case one transverse carriage which can be displaced individually along horizontal displacement axes in the second horizontal main axial direction.

13. The hobbing machine as claimed in claim 3, wherein the n workpiece headstock units are fixed on in each case one transverse carriage which can be displaced individually along horizontal displacement axes in the second horizontal main axial direction.

14. The hobbing machine as claimed in claim 4, wherein the n workpiece headstock units are fixed on in each case one transverse carriage which can be displaced individually along horizontal displacement axes in the second horizontal main axial direction.

15. The hobbing machine as claimed in claim 2, wherein the n-fold milling head is fixed on a vertical carriage which can be displaced along a vertical displacement axis in a vertical main axial direction.

16. The hobbing machine as claimed in claim 3, wherein the n-fold milling head is fixed on a vertical carriage which can be displaced along a vertical displacement axis in a vertical main axial direction.

17. The hobbing machine as claimed in claim 4, wherein the n-fold milling head is fixed on a vertical carriage which can be displaced along a vertical displacement axis in a vertical main axial direction.

18. The hobbing machine as claimed in claim 5, wherein the n-fold milling head is fixed on a vertical carriage which can be displaced along a vertical displacement axis in a vertical main axial direction.
